(19) United States
(12) Patent Application Publication
(10) Pub. No.: US 2005/0217515 A1
(43) Pub. Date: Oct. 6, 2005

(54) Compacting method and apparatus

(76) Inventor: J. Brian Bagwell, Darlington, SC (US)

Correspondence Address: SARA A. CENTIONI;NEXSEN PRUET, LLC, POST OFFICE DRAWER 2426, COLUMBIA, SC, 29202-2426, US

(21) Appl. No.: 10/816,058

(22) Filed: Apr. 1, 2004

(51) Int. Cl. B30B 1/00

(52) U.S. Cl. 100/265; 100/35

(57) ABSTRACT

A compaction system and method including a forklift apparatus that engages a compaction weight. The compaction weight is lifted by the forklift apparatus over the open top of a roll off container. Thereafter, the weight is lowered into the roll off container to compact the refuse within the roll off container.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

The present invention relates to a compacting method and apparatus, and, in particular, a compacting method and apparatus employing the use of a forklift.

A major concern of metropolitan areas is refuse collection. Typically, industries within these areas incur significant expenses to collect and remove refuse. Current refuse collection systems involve the collection of refuse from local points and the transportation of this refuse to a disposal site located remote to the local points. Because of the hassle and inconvenience involved in refuse collection, these refuse collection systems are typically operated by independent contractors that will charge a fee based on various parameters, including the amount of trips that must be made to the disposal sites.

In the case that a refuse collection fee is directly related to the amount of pickups and the amount of filled refuse containers being picked up, it becomes desirable to pack as much refuse as possible into the containers. Accordingly, a device sometimes used in refuse collection systems is a hydrolic packing ram. Although packing rams generally function to compact the refuse in containers, these rams tend to be very expensive and must be permanently installed and occupy valuable space. Additionally, packing rams require maintenance and electric service.

Accordingly, there remains a need for an inexpensive and effective refuse collection system.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

According to its major aspects and briefly stated, the present invention is a method and system for compacting refuse in refuse containers such as roll off containers. As used herein, the term “roll off containers” refers to a refuse receptacle having an open top that is adapted to be carried by a vehicle, such as a truck. These receptacles are also referred to as “box rollers.” The present system includes a forklift apparatus, which is used to engage a compaction weight. Once engaged, the compaction weight is placed over the open top of a roll off container including refuse. Next, the compaction weight is lowered into the container by the forklift so as to compact the refuse.

A feature of the present invention is the use of a compaction method and system, which includes the combination of a forklift apparatus and a compaction weight. Heretofore, forklifts have been used primarily to lift and transport objects. However, the present invention permits a forklift to be used for the additional task of compacting, which was previously beyond its applicability. Additionally, the combination of a forklift apparatus with a compaction weight provides a relatively simple and economic way of compacting refuse in a receptacle such as a roll off container. As discussed, refuse compactors such as packing rams tend to be both expensive and complex. Further, packing rams must be permanently fixed and occupy valuable docking space for loading and unloading freight. In the present invention, the compaction system is portable and is 75% less than the cost of hydrolic packing rams. Moreover, the compaction system does not require any complicated machinery or special operator skill to implement. Finally, the compaction system can be conveniently stored and transported.

Another feature of the present invention is the use of a compaction weight that is dimensioned to be engaged by a forklift apparatus. The particular dimensions of the compaction weight contribute to the ease and simplicity of the compaction method and system. Furthermore, safety features can be included to the compaction weight to ensure that the forklift apparatus safely and effectively compacts the refuse in a receptacle without misplacing or dropping the weight during compaction.

Yet another feature of the present invention is the use of a compaction weight that is dimensioned to be received by a roll off container. The dimensions of the compaction weight can be particularly suited for compacting refuse within the roll off container. Therefore, the refuse can be most effectively and efficiently compacted without the need for multiple or complex compacting steps.

Other features and advantages of the present invention will be apparent to those skilled in the art from a careful reading of the Detailed Description of the Invention presented below and accompanied by the drawings.

### BRIEF DESCRIPTION OF THE DRAWINGS

In the drawings,

FIG. 1 is a side elevational view of a forklift apparatus and a compaction weight of a compaction system according to a preferred embodiment of the present invention;

FIG. 2 is a perspective view of a compaction weight according to a preferred embodiment of the present invention;

FIG. 3 is a side cross sectional view taken at Line 3-3 of FIG. 2 of a compaction weight according to a preferred embodiment of the present invention;

FIG. 4A is a front cross sectional view taken at Line 2-2 of FIG. 2 of a compaction weight according to a preferred embodiment of the present invention;

FIG. 4B and 4C are alternative detailed cross sectional views of the tine-receiving channels, according to a preferred embodiment of the present invention;

FIG. 5 is a perspective view of a safety feature of a compaction system according to a preferred embodiment of the present invention;

FIG. 6A is a side elevational view of a forklift apparatus and a compaction weight of a compaction system, with tines inserted in the channels of the compaction weight, according to a preferred embodiment of the present invention;

FIG. 6B is a side elevational view of a compaction system and a refuse receptacle, with compaction weight shown lifted by fork lift, according to a preferred embodiment of the present invention;

FIG. 6C is a side elevational view of a compaction system and a refuse receptacle, with lifted compaction weight poised over refuse receptacle, according to a preferred embodiment of the present invention;

FIG. 6D is a side elevational view of a compaction system with a refuse receptacle shown during compaction according to a preferred embodiment of the present invention;

FIG. 6E is a side elevational view of a compaction system with a refuse receptacle shown after compaction according to a preferred embodiment of the present invention;

FIG. 7 is a flow chart of a process according to a preferred embodiment of the present method.

### DETAILED DESCRIPTION OF THE INVENTION

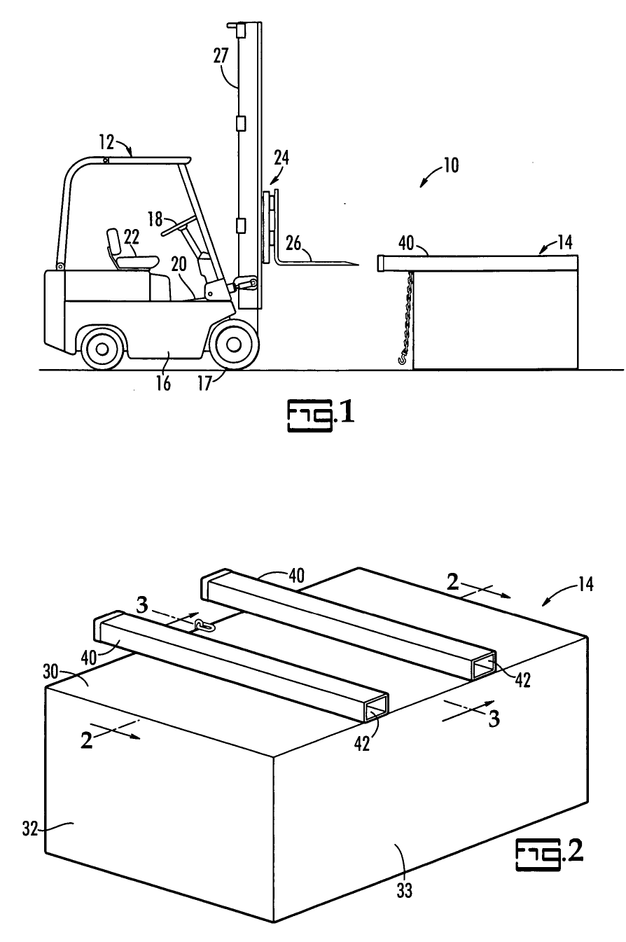

Referring now to FIG. 1, there is shown a compaction system 10 of the present invention. As illustrated, the compaction system 10 includes a forklift apparatus 12 and a compaction weight 14. The particular features of the forklift apparatus 12 are not critical. Generally, the forklift apparatus 12 can include a conventional forklift chassis 16 including a frame being conventionally mounted upon a wheel assembly including axle members (not shown) and wheel members 17. A conventional drive assembly is conventionally mounted to the conventional forklift chassis 16 and includes a steering mechanism 18 and a foot pedal 20 being functionally and conventionally positioned at the front end of the forklift chassis 16. Forklift apparatus 12 further includes a seat 22 for a forklift operator. Finally, a conventional lift assembly 24 including a plurality of lifting tines 26 is movably and conventionally mounted upon a mast 27 located at the front end of the forklift chassis 16.

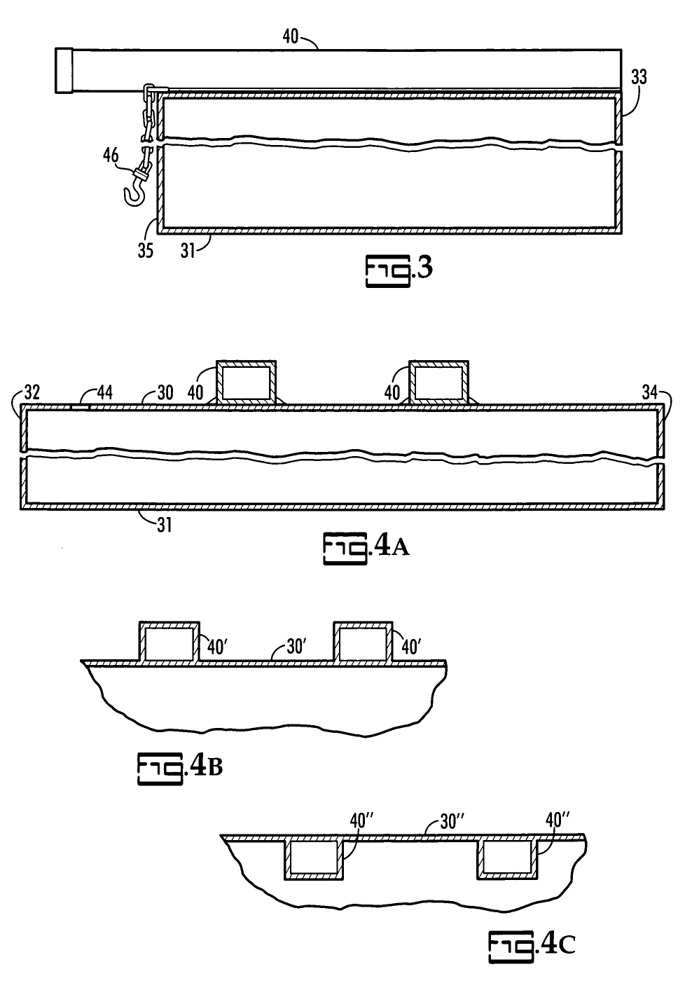

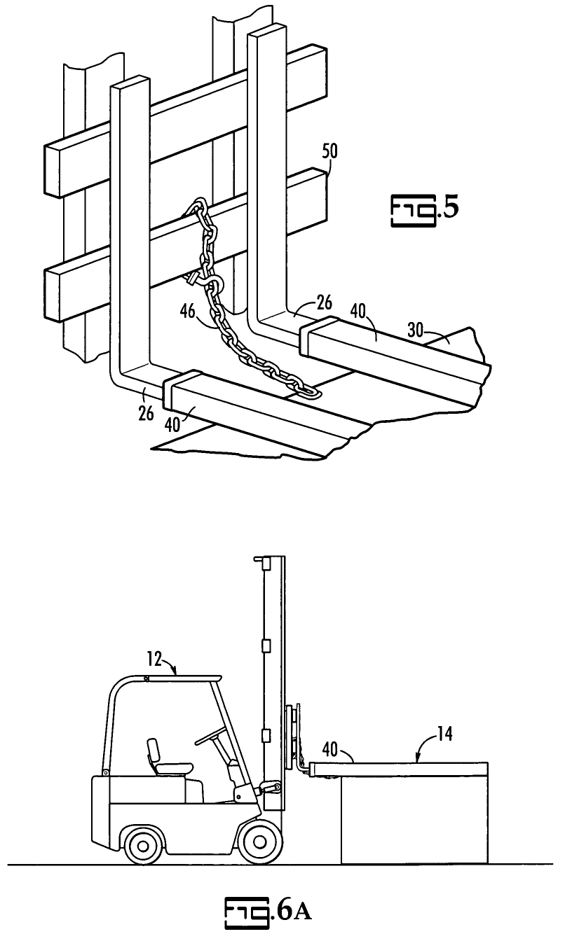

The compaction weight 14 of the present invention is shown in detail in FIGS. 2-4. As illustrated, the compaction weight 14 generally has a box-like shape including a top surface 30 and an opposing bottom surface 31, which are connected along the edges by side walls, 32, 33, 34, 35 perpendicular to the top surface 30 and bottom surface 31. Although no particular material is required for the construction of the compaction weight, preferably, the weight is made of a type of metal suitable for industrial applications, such as steel. On the top surface 30, the compaction weight 14 carries means for engaging 40 forklift tines 26 such as channels 40. Channels 40 are dimensioned to receive the tines 26 whereby the tines 26 are inserted into plural apertures 42. Although channels 40 are shown in FIG. 4A as being carried on the top surface 30 such as by welding; alternatively, channels 40′ could be formed integrally with the top surface 30′, as shown in FIG. 4B. Additionally, channels 40″ could be formed integrally beneath the top surface 30″ so that channels 40″ are built into the body of the compaction weight 14, as shown by FIG. 4C. What is important to the practice of the invention is that the tines 26 of the forklift apparatus 12 include apertures in channels 40 dimensioned and formed to receive tines 26 so as to engage and support the compaction weight 14.

Within its outer surfaces, the compaction weight 14 is hollow and adapted to receive a mass to add the sufficient amount of weight for the practice of the present compaction method. For example, the compaction weight 14 can include plated steel, as well as crushed asphalt or cement. Additionally, the compaction weight 14 can include a flowable mass, such as water or sand. The particular material that is included within the weight 14 will depend on both the types of refuse being compacted, as well as the lifting power of forklift apparatus 10 employed. In making the compaction weight, the top surface 30 of the weight can be welded onto the weight after the weight 14 is appropriately filled with mass. Alternatively, the compaction weight 14 can include an inlet or port 44 that can receive flowable mass.

A particular feature of the present invention is the use of a compaction method and system, which includes the combination of the forklift apparatus 12 and the compaction weight 14. Heretofore, forklifts have been used primarily to lift and transport objects. However, the present invention permits a forklift to be used for the additional task of compacting, which was previously beyond its applicability. Additionally, the combination of forklift apparatus 12 with compaction weight 14 provides a relatively simple and economic way of compacting refuse in a receptacle such as a roll off container. Because refuse compactors such as packing rams tend to be both expensive and complex and can take up a large amount of space within the receptacle, the compaction system 10 of the present invention is advantageous because it takes up no space within the refuse receptacle so that the receptacle can hold as much refuse as can be packed into it. Moreover, the compaction system 10 does not require any complicated machinery or special operator skill to implement.

As shown in FIG. 3, the compaction weight 14 of the present invention can also include means for securing compaction weight 14 to forklift apparatus 10, such as a cable or a chain 46. Chain 46 adds a safety feature to the compaction system 10, because it ensures that compaction weight 14 remains engaged to the forklift apparatus 12 during operation.

As previously discussed, another feature of the present invention is the use of compaction weight 14 dimensioned to be engaged by forklift apparatus 12. The particular dimensions of the compaction weight 14 contribute to the ease and simplicity of the compaction method and system. Furthermore, the use of the chain 46 contributes to the safe and effective compacting of refuse in a receptacle, and minimizes the concern of misplacing or dropping the weight 14 during compaction.

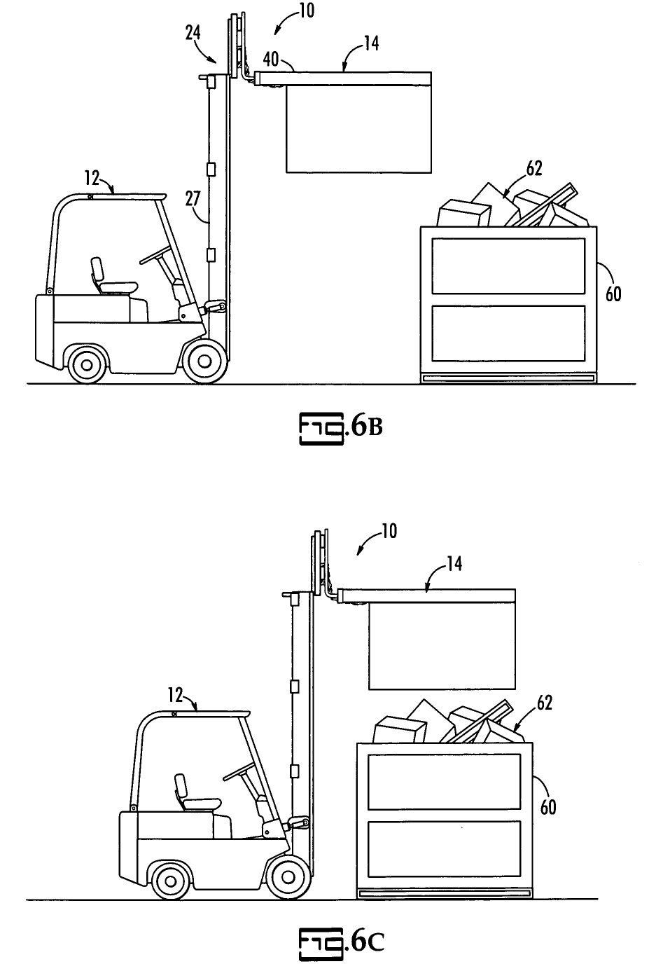

In use, as shown in FIG. 5, the chain 46 is wrapped around a rigid member that forms part of the forklift apparatus 12 such as a tine support 50. Further, FIG. 5 shows how the tines 26 of the forklift apparatus 12 fit telescopically within the channels 40 to provide a secure and effective hold on the compaction weight 14.

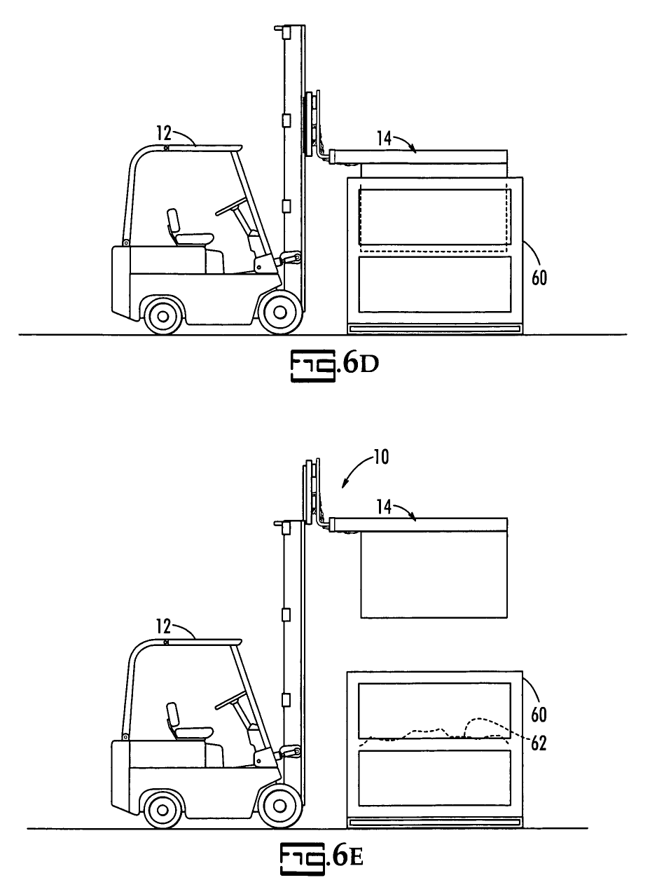

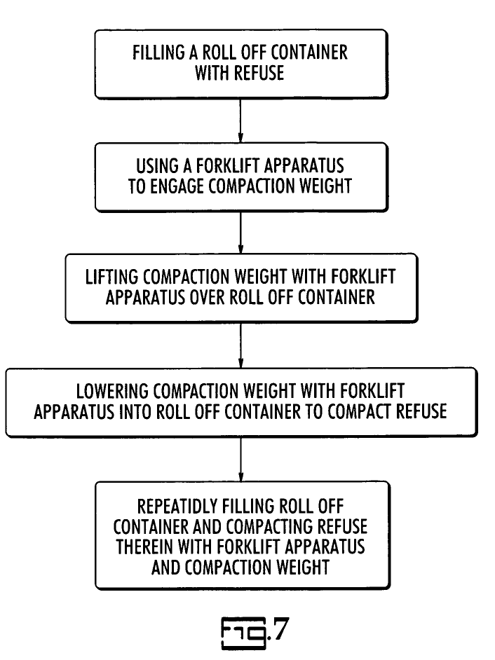

FIGS. 6A-6E illustrate the compaction method of the present invention, and FIG. 7 provides a flow chart summarizing this process. As shown, the forklift apparatus 12 engages the compaction weight 14. In particular, the tines 26 of the forklift apparatus 12 are lifted by the forklift operator to an elevation that is level with the channels 40 of the compaction weight 14. Next, the tines 26 are inserted into the apertures 42 of the engaging means 40. Optionally, the chain 46 is attached to the forklift apparatus 12.

Once the compaction weight 14 has been effectively secured to the forklift apparatus 12, the lift assembly 24 operates to lift the compaction weight 14 to an elevation that will be sufficient to clear the top edge of a roll off container 60. The compaction weight 14 is next brought forward by the forklift apparatus 12 so that the compaction weight 14 is directly above refuse 62 contained by the roll off container 60. To compact the refuse, the compaction weight 14 is simply lowered into the roll off container 60. Finally, the compaction weight 14 is lifted and removed by the forklift apparatus 12 leaving behind a compacted roll off container 60. Thereafter, additional refuse 62 can be added to the roll off container 60, and the compacting steps can be repeated until the roll off container 60 is filled with compacted refuse.

Although the particular dimensions of the compaction weight 14 are not critical to the practice of the invention, preferably, the compaction weight 14 is dimensioned to be received by or fit within a standard roll off container 60. Accordingly, the length, width, and depth of the compaction weight 14 is such that the roll off container 60 can receive compaction weight 14. For example, the length of the compaction weight 14 taken along the longitudinal horizontal axis at Line 2-2, shown in FIG. 2, is preferably less than the length of the roll off container 60 taken along its longitudinal horizontal axis. Standard roll off containers 60 range from approximately 22 feet in length, approximately 6 to approximately 8 feet in width, approximately 4 to approximately 7 feet in depth. Generally, these roll off containers exist in three main sizes that are capable of handle 20, 30, and 40 yards of volume of refuse.

It will be apparent to those skilled in the art that many changes and substitutions can be made to the preferred embodiment herein described with departing from the spirit and scope of the present invention as defined by the appended claims.

1. A compaction system, comprising:
a forklift apparatus; and
a compaction weight, wherein said forklift has a plurality of tines and wherein said compaction weight has means for engaging said plurality of tines so that said forklift apparatus can lift said compaction weight.

2. The compaction system as recited in claim 1, wherein said engaging means is dimensioned to receive said plurality of tines.

3. The compaction system as recited in claim 1, wherein said compaction weight includes a top surface, an opposing bottom surface, and side walls that are perpendicular to said top surface and said bottom surface and that connect said top surface and said bottom surface.

4. The compaction system as recited in claim 3, wherein said engaging means is formed integrally with said top surface.

5. The compaction system as recited in claim 3, wherein said engaging means is carried on top of said top surface.

6. The compaction system as recited in claim 1, further comprising means for securing said compaction weight to said forklift apparatus.

7. A compaction system, comprising:
a forklift apparatus having a plurality of tines; and
a compaction weight having means for engaging said plurality of tines; and
a roll off container, wherein said compaction weight is dimensioned to be received by said roll off container.

8. The compaction system as recited in claim 7, wherein said engaging means is dimensioned to receive said plurality of tines.

9. The compaction system as recited in claim 7, wherein said compaction weight includes a top surface, an opposing bottom surface, and side walls that are perpendicular to said top surface and said bottom surface and that connect said top surface and said bottom surface along the edges of said top surface and said bottom surface.

10. The compaction system as recited in claim 9, wherein said engaging means is formed integrally with said top surface.

11. The compaction system as recited in claim 9, wherein said engaging means is carried on top of said top surface.

12. The compaction system as recited in claim 7, further comprising means for securing said compaction weight to said forklift apparatus.

13. A method for compacting refuse within a roll off container, comprising the steps of:
providing a roll off container with an open top;
placing refuse in said roll off container;
providing a forklift apparatus having a plurality of tines;
providing a compaction weight having channels formed therein;
elevating said plurality of tines to the same elevation of said channels;
inserting said plurality of tines within said channels;
elevating said compaction weight with said forklift apparatus to an elevation that is above the top edge of a roll off container;
moving said compaction weight with said forklift apparatus over said roll off container; and
lowering said compaction weight with said forklift apparatus onto said refuse in said roll off container to compact said refuse.

14. The method for compacting as recited in claim 13, further comprising the step of securing said compaction weight to said forklift apparatus.

15. The method for compacting as recited in claim 13, further comprising the steps of:
elevating said compaction weight with said forklift apparatus after said lowering step;
filling said compacted roll off container with additional refuse; and
repeating said lowering steps to compact said additional refuse.
